(19) United States
(12) Patent Application Publication
(10) Pub. No.: US 2015/0269673 A1
(43) Pub. Date: Sep. 24, 2015

(54) SYSTEMS, METHODS, AND MEDIA FOR REDUCING AGGREGATE PORTFOLIO STATISTICS

(71) Applicant: LCH.CLEARNET LIMITED, NEW YORK, NY (US)

(72) Inventors: Paul A. Wilson, Kent (GB); Philip H. Whitehurst, London (GB)

(21) Appl. No.: 14/547,713

(22) Filed: Nov. 19, 2014

Related U.S. Application Data
(60) Provisional application No. 61/955,534, filed on Mar. 19, 2014.
(60) Provisional application No. 62/026,296, filed on Jul. 18, 2014.

(51) Int. Cl. G06Q 40/04

(52) U.S. Cl. CPC G06Q 40/04

(57) ABSTRACT

Methods, systems and computer program products are provided for reducing aggregate portfolio statistics. Two or more trades that can be netted are identified. The two or more trades have different fixed rates. A net of underlying trade cash flows of the two or more trades is represented by replacing the two or more trades with two or fewer replacement trades having an aggregate notional amount that is smaller than an aggregate notional amount of the two or more trades.

### CROSS REFERENCE TO RELATED APPLICATION

This application claims priority to U.S. Provisional Application No. 61/955,534, filed Mar. 19, 2014, and to U.S. Provisional Application No. 62/026,296, filed Jul. 18, 2014, the contents of which are incorporated herein by reference.

### BACKGROUND

1. Field

Example aspects described herein relate generally to trading financial instruments, and more particularly to executing trades in financial instruments.

2. Related Art

An Interest Rate Swap (IRS) is an agreement to swap a series of cash flows, sometime referred to as coupons, between the two parties to the trade. Whilst there are many sub-types of IRSs, the most common type is to swap a series of cash flows based on a notional (theoretical) amount at a fixed rate with another series of cash flows based on the same notional amount, but where the rate used to calculate the cash flow is variable. This variable rate is based on industry recognized published rates. The notional amount, frequency of the cash flows, fixed rate and which floating rate to use, are trade details agreed at the time of executing the trade, as is the duration of the trade. The fixed rate of the trade is often viewed as the price of the trade.

A central counterparty (CCP) service, with respect to IRSs, steps into IRS trades executed between entities. Once the CCP has become counterparty to both sides of the IRS trade, it guarantees the performance of the trade to both sides, thereby removing the original bilateral counterparty risk.

To maximise capital efficiency, the amount of gross notional on IRS trades needs to be as low as possible to achieve the interest rate risk position an entity is taking.

### BRIEF DESCRIPTION

The example embodiments described herein provide methods, systems and computer program products for reducing aggregate portfolio statistics. Two or more trades that can be netted are identified. The two or more trades have different fixed rates. A net of underlying trade cash flows of the two or more trades is represented by replacing the two or more trades with two or fewer replacement trades having an aggregate notional amount that is smaller than an aggregate notional amount of the two or more trades.

### BRIEF DESCRIPTION OF THE DRAWINGS

The features and advantages of the example embodiments presented herein will become more apparent from the detailed description set forth below when taken in conjunction with the following drawings.

FIG. 1 illustrates an example system which can be used to implement the embodiments of the invention.

FIG. 2 is a flow diagram of a process for managing trades in accordance with an example embodiment of the invention.

FIG. 3 is a flow diagram of another process for managing trades in accordance with an example embodiment of the invention.

FIG. 4 is a block diagram of an exemplary hardware system useful for implementing the present invention.

### DETAILED DESCRIPTION

In accordance with some embodiments, mechanisms for reducing aggregate portfolio statistics in financial instruments are provided. In some embodiments, these mechanisms can receive information relating to trades, can identify trades which can be netted, and can represent the netted trades with one or more replacement trades. In selecting trades that can be netted against one another, one common existing requirement that may often exist is that the fixed rate of the trades must be identical. Nevertheless, as described below, example embodiments described herein enable trades whose fixed rates are different from one another to be netted. While the description below is explained in the context of a CCP service acting as an intermediary, it should be understood that aspects of the embodiments herein could be performed by other entities.

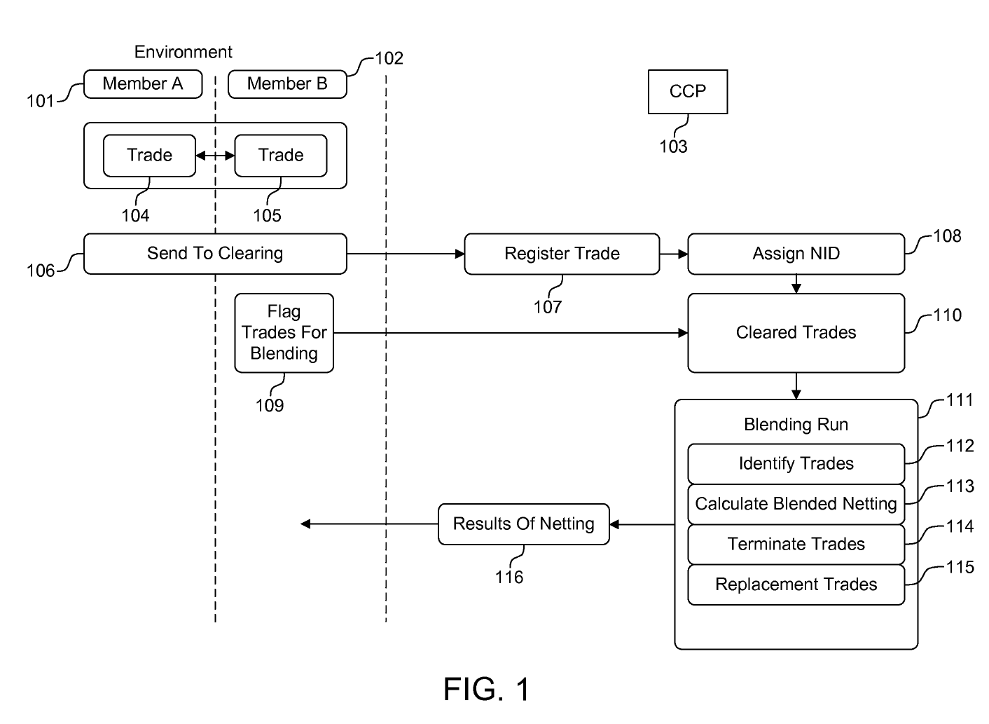

FIG. 1 illustrates an example system which can be used to implement the embodiments of the invention. In particular, in FIG. 1, member system 101 (also referred to as “Member A”), member system 102 (also referred to as “Member B”) and central counterparty (CCP) 103 communicate across one or more networks (not shown).

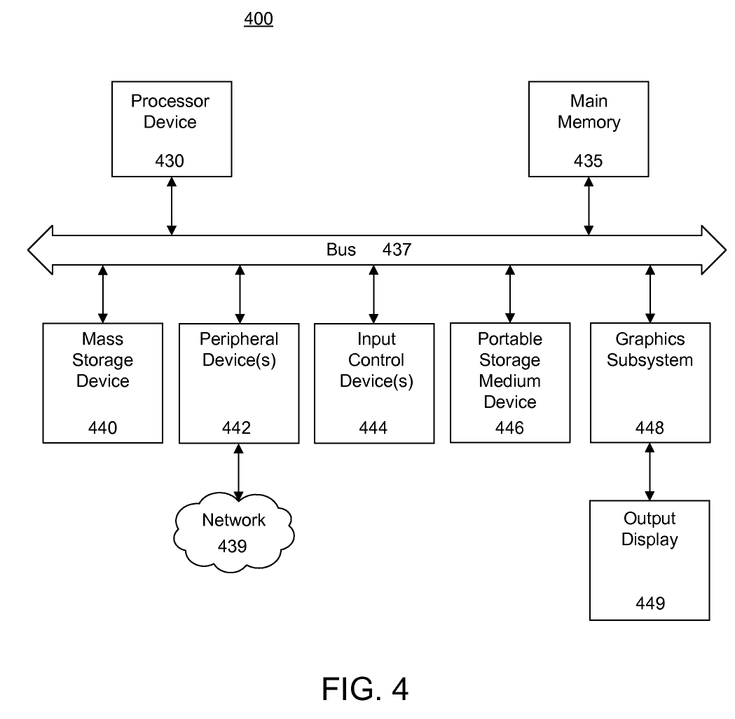

Any one or more of member system 101, member system 102 or CCP 103 can be implemented as a general purpose device such as a computer or a special purpose device such as a client, a server, etc. Any of these general or special purpose devices can include any suitable components such as a hardware processor (which can be a microprocessor, digital signal processor, a controller, etc.), memory, communication interfaces, display controllers, input devices, etc. An example of hardware corresponding to any of member system 101, member system 102 or CCP 103 is described more fully below with respect to FIG. 4.

As shown in FIG. 1, member system 101 proposes a trade 104 and member system 102 proposes a trade 105, and the trades are communicated to the other party. Each of the proposed trades are sent to the clearing (e.g., sent to a clearinghouse, CCP 103 or other entity to verify that the trade is acceptable) in a step 106, and in step 107 the proposed trades are registered (e.g., with CCP 103). In step 108, a netting identifier reference (NID) is assigned to each trade. In step 109, member system 102 (or member system 101) flags the trades 104 and 105 for potential blending. In step 110, the flagged trades 104 and 105 are cleared for blending in a process described more fully below.

Thus, a blending run 111 is initiated. In step 112, the trades that can be netted are identified. In step 113, a blended netting is calculated. In step 114, the previous trades are terminated, and in step 115, replacement trades are generated. In step 116, the results of the netting are transmitted to member system 102 and/or member system 101. Example aspects of these processes will be described more fully below.

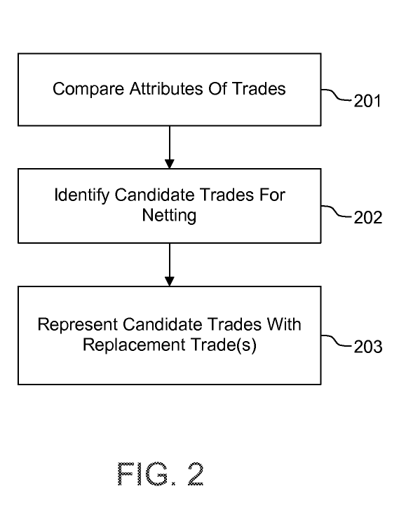

FIG. 2 is flow diagram of another process for managing trades in accordance with an example embodiment of the invention. Briefly, in FIG. 2, aggregate portfolio statistics are reduced. Two or more trades that can be netted are identified. The two or more trades have different fixed rates. A net of underlying trade cash flows of the two or more trades is represented by replacing the two or more trades with two or fewer replacement trades having an aggregate notional amount that is smaller than an aggregate notional amount of the two or more trades.

In more detail, in step 201, attributes of trades are compared. In that regard, when trades are submitted for clearing, the CCP 103 evaluates the trade and compares all of the attributes of the trade that can affect the amount, direction and value date of any of its cash flows from the last payment of the trade backwards. If the trade being evaluated is the first trade that presents the CCP 103 with that given combination of attributes, the trade is assigned a new NID. On the other hand, if a new trade has the same combination of attributes as a trade previously processed by the CCP 103, the NID previously assigned to the previous trade is also assigned to the new trade. The fixed rate of the trade is not an attribute contributing to the NID profile. This process enables the CCP 103 to identify trades with the same economic profile excluding the fixed rate.

In step 202, there is identification of candidate trades for netting. For example, there is an identification of two or more trades which can be netted, where the two or more trades have different fixed rates. Thus, in one example, the identifying of trades that can be netted includes comparing the plurality of attributes of the two or more trades, correspondingly.

Whilst the NID describes trades with the same economic profile, it does not guarantee trades with the same NID have exactly the same future cash flow profile. This is because when a trade starts to generate payments is not an attribute included in the NID. To ensure future cash flow profiles align when identifying trades to net, the CCP 103 also takes into account the accrual start date for the next payment to be settled of both of cash flows (fixed and variable). By combining the NID and the next payment accrual dates of trades, the CCP 103 is able to identify trades that have the same future cash flow profile but have different fixed rates. These are candidates for the coupon blending process.

In step 203, a “blending run” is performed. Specifically, a net of underlying trade cash flows of the two or more trades is represented, by replacing the two or more trades with two or fewer replacement trades having an aggregate notional amount that is smaller than an aggregate notional amount of the two or more trades. In a blending run, any trades marked for inclusion will be assessed against other included trades that have the same NID and accrual dates. If a blending opportunity is available, the original trades are terminated and replaced with other trades that generate the same net cash flows based of the result of the netting process.

In one example, the two or fewer replacement trades is either one of (i) a fixed fixed interest rate swap trade, (ii) an interest rate swap trade, (iii) a combination of a fixed fixed interest rate swap trade and an interest rate swap trade, or (iv) two interest rate swap trades, representing the net of residual fixed side cash flows. When the two or fewer replacement trades are two interest rate swap trades, one of the two interest rate swap trades can be a pay-fixed interest rate swap at a lowest fixed rate of the two or more trades minus a predetermined percentage and the other one of the two interest rate swap trades can be a received-fixed interest rate swap at a highest fixed rate of the two or more trades plus the predetermined percentage, as discussed more fully below.

In another example, the blending run includes calculating a net notional amount of the two or more trades, and upon determining that the net notional amount is zero, calculating a net of residual fixed side cash flows of the two or more trades, determining whether the net residual fixed side cash flows of the two or more trades are outstanding, and, upon determining that the net residual fixed side cash flows are outstanding, booking two replacement trades to represent the residual fixed side cash flows of the two or more trades. The blending run may also include, upon determining that the net residual fixed side cash flows of the two or more trades are not outstanding, terminating the two or more trades, and upon determining that the net notional amount of the two or more trades is not zero, calculating a range based on a minimum and maximum of a plurality of fixed rates of the two or more trades, varying the range by a predetermined percentage, and calculating a notional-weighted average fixed rate to apply to a net notional amount of a replacement trade.

The blending run may further include, upon determining that the notional-weighted average fixed rate is outside the range, replacing the two or more trades with the two replacement trades, correspondingly, and terminating the two or more trades. Meanwhile, the process also includes, upon determining that the notional-weighted average fixed rate is within the range, determining that the notional-weighted average fixed rate generates a cash flow equal to the net fixed cash flows of the two or more trades, replacing the two or more trades with the replacement trade at the notional-weighted average fixed rate, correspondingly, and terminating the two or more trades, and, upon determining that the notional-weighted average fixed rate generates a cash flow that is not equal to the net fixed cash flows of the two or more trades, booking two replacement trades in place of the two or more trades at rates with the net notional amount distributed across the two replacement trades to generate fixed cash flows equal to the net fixed cash flows of the two or more trades, correspondingly.

In another aspect, the cash flow generated by the notional-weighted average fixed rate is compared to the net fixed cash flows of the two or more trades based on a predetermined level of rounding, as described below.

In one aspect, CCP 103 would host for its members regular coupon blending runs. Member participation would be voluntary in this process and so for a trade to be included in the coupon blending run, a member would enrich the trade at the CCP 103 to request the trade be included in the coupon blending run. Members will perform this enrichment by, for example, sending the CCP 103 a message over a proprietary message infrastructure, or through an internet-based file delivery service.

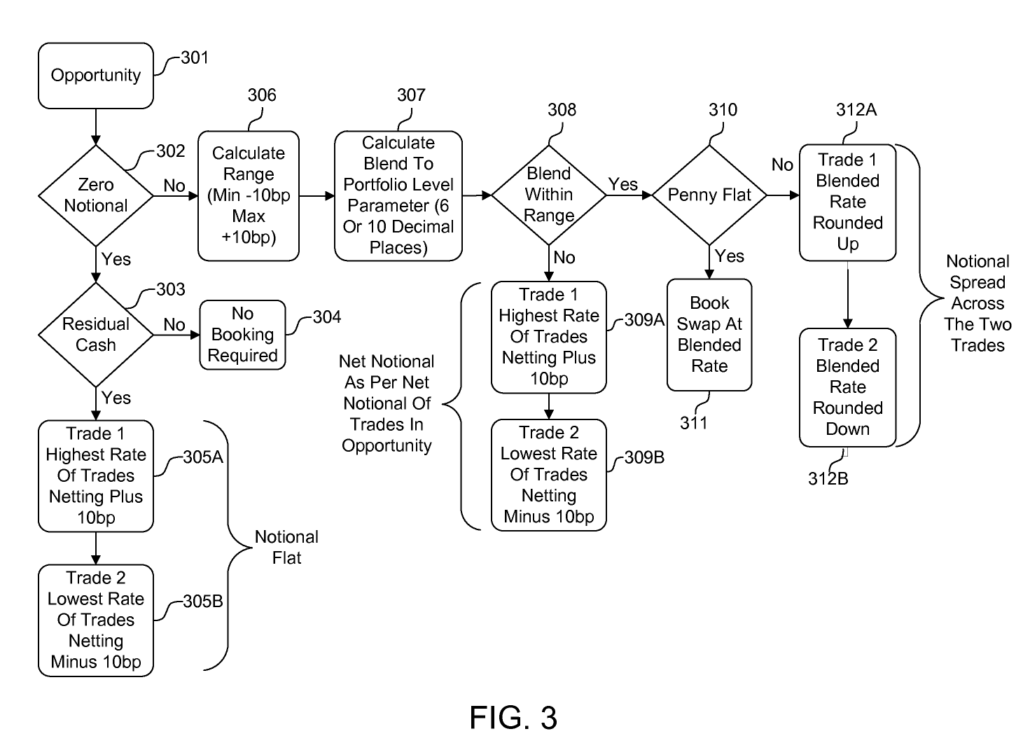

A more detailed example of the above processes will now be described with respect to FIG. 3.

FIG. 3 is flow diagram of another process for managing trades in accordance with an example embodiment of the invention. In step 301, there is an identification of an “opportunity”. Specifically, there is identification of a set of trades that can be included in the blending run, i.e., those that have the same NID and future cash flow.

In step 302, the net notional of the blending opportunity is calculated. In one aspect, a pay fixed rate trade is treated as a negative notional and a receive fixed rate trade is treated as a positive notional. There is a determination of whether the net notional is zero. If the net notional is zero, the process proceeds to step 303, and if the net notional is not zero, the process proceeds to step 306.

In step 303, there is a determination of whether any residual fixed cash flows are outstanding. If there are no residual fixed cash flows outstanding, the process proceeds to step 304. If there are residual fixed cash flows outstanding, the process proceeds to step 305A.

In step 304, i.e., in the case where no residual fixed cash flows are outstanding, then the underlying trades can be terminated and no replacement trade is required.

On the other hand, if the result of step 303 indicates that residual fixed cash flows have to be represented, the process proceeds to steps 305A and 305B, where the trades in the blending opportunity are terminated and two replacement trades are booked to represent the residual fixed cash flows.

The two replacement trades, one a pay fixed one a receive fixed, are booked, with one trade generated at step 305A at the highest fixed rate of the underlying trades, increased by a predetermined percentage (e.g. 0.10%), and the other trade generated in step 305B, at the lowest fixed rate of trades being netted minus a predetermined percentage (e.g. 0.10%). Both the replacement trades will have the same notional with the notional amount being derived so that the two trades, when combined offset each other in terms of notional and therefore the floating side but generate the residual fixed flows.

The following tables illustrate an example of a blending opportunity and the replacement trades.

Blending Opportunity

| | | Pay/Rec | | Fixed | Annualized |
|---|---|---|---|---|---|
| Trade Ref. | NID | (Fixed) | Notional | Rate | Cash Flow |
| 1354423 | 1234 | Rec | 400,000,000 | 0.95% | 3,800,000.00 |
| 1357245 | 1234 | Rec | 100,000,000 | 0.93% | 930,000.00 |
| 1352711 | 1234 | Rec | 100,000,000 | 0.90% | 900,000.00 |
| 1360749 | 1234 | Pay | −400,000,000 | 0.86% | −3,440,000.00 |
| 1361245 | 1234 | Rec | 200,000,000 | 0.85% | 1,700,000.00 |
| 1349895 | 1234 | Pay | −400,000,000 | 0.82% | −3,280,000.00 |

Replacement Trades

| | | Pay/Rec | | Fixed | Annualized |
|---|---|---|---|---|---|
| Trade Ref. | NID | (Fixed) | Notional | Rate | Cash Flow |
| 1456599 | 1234 | Rec | 184,848,484.85 | 1.0500% | 1,940,909.09 |
| 1456600 | 1234 | Pay | −184,848,484.85 | 0.7200% | −1,330,909.09 |
| | | | | | 610,000.00 |

In this example, one of the replacement trades is booked at a rate of 1.05% being the highest rate of 0.95% plus 0.1% and the other at 0.72% being the lowest rate of 0.82% minus 0.1%. The notional is derived to be the amount required at the difference in the rates to be used to generate the net fixed cash flow. As the net cash flow is positive, the higher rate is applied to the receive fixed trade. The notional on the replacement trade is calculated to achieve the required cash flow when using a rate of 0.95%.

Returning to FIG. 3, if in step 302 the net notional is not zero, then the process proceeds to step 306, where a range is derived based on the minimum and maximum of the fixed rates of the underlying trades and increased up and down by a pre-determined percentage (e.g. 0.10%). In one example embodiment the fixed rate on any replacement trades should be within this range.

In step 307, the blended (weighted average) fixed rate required to be applied to the net notional replacement trade is calculated, for example:

Blending Opportunity

| | | Pay/Rec | | Fixed | Annualized |
|---|---|---|---|---|---|
| Trade Ref. | NID | (Fixed) | Notional | Rate | Cash Flow |
| 1354423 | 1234 | Rec | 50,000,000 | 2.340% | 1,170,000.00 |
| 1357245 | 1234 | Rec | 50,000,000 | 2.360% | 1,180,000.00 |
| 1352711 | 1234 | Rec | 50,000,000 | 2.340% | 1,170,000.00 |
| 1360749 | 1234 | Pay | −200,000,000 | 2.320% | −4,640,000.00 |
| 1361245 | 1234 | Rec | 50,000,000 | 2.280% | 1,140,000.00 |
| 1349895 | 1234 | Pay | −200,000,000 | 2.340% | −4,680,000.00 |
| | | | −200,000,000 | | −4,660,000 |

Blended Rate

| | |
|---|---|
| Annual - (Coupon/Net Notional) | 2.33000% |

In this example, the annualised cash flow per trade is the annual interest due on the notional at the fixed rate, and the replacement rate is calculated as the rate required to achieve an annual cash flow of the net cash flow when applied to the net notional. This replacement rate can be calculated to, e.g., 10 decimal places (i.e., x.1234567891) or 6 decimal places based on member preference. Members can increase from 6 to 10 decimal places when their systems can support it.

In step 308, the blended rate calculated in step 307 is validated against the range calculated in step 306. If the blended rate is not within the range, the process proceeds to steps 309A and 309B, whereas if the blended rate is within the range, the process proceeds to step 310.

In step 309, i.e., if the blended rate calculated in step 307 is outside of the allowed range defined in step 306, two replacement fixed float bookings are made and the underlying trades are terminated. The two fixed rates used on the replacement trades can be, in a first trade 1 generated in step 309A, the highest fixed rate of the underlying trades increased by a pre-determined percentage (e.g. 0.10%) and, in a trade 2 generated in step 309B, the lowest fixed rate of trades being netted minus a pre-determined percentage (e.g. 0.10%). Two notional values are derived so that when applied to the fixed rates the required fixed cash flows are generated as well as the required net notional, for example:

Blending Opportunity

| | | Pay/Rec | | | Annualized |
|---|---|---|---|---|---|
| Trade Ref. | NID | (Fixed) | Notional | Fixed Rate | Cash Flow |
| 1354423 | 1234 | Pay | −100,000,000 | 3.000% | −3,000,000.00 |
| 1357245 | 1234 | Pay | 99,000,000 | 3.168% | 3,136,320.00 |
| | | | −1,000,000 | | 136,320.00 |

Blended Rate

| | |
|---|---|
| Annual - (Coupon/Net Notional) | −13.63200% |

Blended Rate Check

| Rate Band | Trades | Range | Vs Blended |
|---|---|---|---|
| Min Rate | 3.000% | 2.900% | FALSE |
| Max Rate | 3.168% | 3.268% | TRUE |
| Spread | | 0.368% | |

Replacement Trades

| | | Pay/Rec | | Fixed | Annualized |
|---|---|---|---|---|---|
| Trade Ref. | NID | (Fixed) | Notional | Rate | Cash Flow |
| 1456599 | 1234 | Rec | 44,923,913.04 | 3.268% | 1,468,113.48 |
| 1456605 | 1234 | Pay | −45,923,913.04 | 2.900% | −1,331,793.48 |
| | | | −1,000,000.00 | | 136,320.00 |

In this example the blended rate (−13.632%) is lower than the permitted value. The two rates to be applied to the replacement trades are 3.268% and 2.90%, being the highest and lowest rates of the underlying trades including a 0.10% adjustment. Each trade has a notional assigned which, when both replacement trades are combined, generate the required net notional and net fixed cash flows.

Returning to step 308, if the blended rate calculated in step 307 is within the range from step 306, the process proceeds to step 310, where a check is performed to validate that if the blended rate when applied to the net notional generates a cash flow equal to the net fixed cash flows of the underlying trades in the netting opportunity. If a member has elected to have their blended rate rounded to 6 decimal places rather than 10, the blended rate is less likely to achieve an exact replication of the net underlying cash flows. If the blended rate replicates the net fixed cash flows of the original trades, the process proceeds to step 311.

In step 311, the net fixed cash flows of the original trades are terminated, and a replacement trade is created, for example:

Blending Opportunity

| | | Pay/Rec | | | Annualized |
|---|---|---|---|---|---|
| Trade Ref. | NID | (Fixed) | Notional | Fixed Rate | Cash Flow |
| 1354423 | 1234 | Rec | 50,000,000 | 2.340% | 1,170,000.00 |
| 1357245 | 1234 | Rec | 50,000,000 | 2.360% | 1,180,000.00 |
| 1352711 | 1234 | Rec | 50,000,000 | 2.340% | 1,170,000.00 |
| 1360749 | 1234 | Pay | −200,000,000 | 2.320% | −4,640,000.00 |
| 1361245 | 1234 | Rec | 50,000,000 | 2.280% | 1,140,000.00 |
| 1349895 | 1234 | Pay | −200,000,000 | 2.340% | −4,380,320.00 |
| | | | −200,000,000 | | −4,660,000.00 |

Blended Rate

| | |
|---|---|
| Annual - (Coupon/Net Notional) | 2.33000% |

Blended Rate Check

| Rate Band | Trades | Range | Vs Blended |
|---|---|---|---|
| Min Rate | 2.280% | 2.180% | TRUE |
| Max Rate | 2.360% | 2.460% | TRUE |
| Spread | | 0.280% | |

Replacement Trades

| | | Pay/Rec | | Fixed | Annualized |
|---|---|---|---|---|---|
| Trade Ref. | NID | (Fixed) | Notional | Rate | Cash Flow |
| 1456578 | 1234 | Rec | −200,000,000.00 | 2.330% | −4,660,000.00 |
| | | | −200,000,000.00 | | −4,660,000.00 |

In this example, the rate of the replacement trade is the calculated blended rate of 2.33%, as it is within the allowed range 2.180% to 2.460%. The notional is the net notional of the underlying trades. All the other attributes of the replacement trade are taken from the profile of the underlying trades.

On the other hand, if the blended rate does not replicate the net fixed cash flows of the underlying trades, the process proceeds to steps 312A and 312B, where two replacement swaps are booked. One of these trades, generated at step 312A, will be the blended rate rounded up to 6 decimal places. The other trade, generated in step 312B, will be booked at a fixed rate that is the blended rate rounded down to 6 decimal places. The net notional of the underlying trades is distributed across the two trades in such a way that the net fixed cash flow of both of them equals the net fixed flow of the underlying trades:

Blending Opportunity

| | | Pay/Rec | | Fixed | Annualized |
|---|---|---|---|---|---|
| Trade Ref. | NID | (Fixed) | Notional | Rate | Cash Flow |
| 1354423 | 1234 | Rec | 81,000,000 | 0.896% | 725,760.00 |
| 1357245 | 1234 | Rec | 40,000,000 | 0.896% | 358,400.00 |
| 1352711 | 1234 | Rec | 185,000,000 | 0.898% | 1,661,300.00 |
| 1360749 | 1234 | Pay | −50,000,000 | 0.910% | −455,000.00 |
| 1361245 | 1234 | Pay | 50,000,000 | 0.910% | 455,000.00 |
| 1349895 | 1234 | Rec | −500,000,000 | 0.915% | −4,575,000.00 |
| | | | −294,000,000 | | −2,739,540.00 |

Blended Rate

| | |
|---|---|
| Annual - (Coupon/Net Notional) | 0.9318163265% |

Blended Rate Check

| Rate Band | Trades | Range | Vs Blended |
|---|---|---|---|
| Min Rate | 0.896% | 0.796% | TRUE |
| Max Rate | 0.915% | 1.015% | TRUE |
| Spread | | 0.219% | |

Rounded Check

| | | |
|---|---|---|
| Blended (Net Coupon/Net Notational) - | 0.9318163265% | 0.00 |
| 10 dp | | |
| Coupon | 2,739,540.00 | |
| Blended (Net Coupon/Net Notational) - | 0.931816000% | 0.00 |
| 6 dp | | |
| Coupon | 2,739,539.04 | |

Solving for the replacement Trades

| | |
|---|---|
| Roundup | 0.9318170000% |
| Rounddown | 0.9318160000% |
| Factor | 0.3265 |

Replacement Trades

| Trade | | Pay/Rec | | | Annualized |
|---|---|---|---|---|---|
| Ref. | NID | (Fixed) | Notional | Fixed Rate | Cash Flow |
| 1456599 | 1234 | Pay | −198,009,000.01 | 0.9318170% | −894,460.46 |
| 145660 | 1234 | Pay | −95,990,999.99 | 0.9318160% | −1,845,079.54 |
| | | | −294,000,000.00 | | −2,739,540.00 |

In this example, the blended rate at 6 decimal points does not generate the required net fixed cash flow. The blended rate is rounded up and down to six decimal places, and two replacement trades are booked, one at the rounded up rate and one at the rounded down rate. The notional of the two replacement trades are derived so that when the trades are combined they generate the required net notional and required net fixed cash flows.

It should be understood that some or all of the above steps of the flow diagrams of FIGS. 1-3 can be executed or performed in an order or sequence other than the order and sequence shown and described in the figures. Also some of the above steps of the flow diagrams of FIGS. 1-3 may be executed or performed well in advance of other steps, or may be executed or performed substantially simultaneously or in parallel to reduce latency and processing times.

FIG. 4 is a block diagram of a general and/or special purpose computer 400, in accordance with some of the example embodiments of the invention. The computer 400 may be, for example, a user device, a user computer, a client computer and/or a server computer, among other things.

The computer 400 may include without limitation a processor device 430, a main memory 435, and an interconnect bus 437. The processor device 430 may include without limitation a single microprocessor, or may include a plurality of microprocessors for configuring the computer 400 as a multi-processor system. The main memory 435 stores, among other things, instructions and/or data for execution by the processor device 430. The main memory 435 may include banks of dynamic random access memory (DRAM), as well as cache memory.

The computer 400 may further include a mass storage device 440, peripheral device(s) 442, portable non-transitory storage medium device(s) 446, input control device(s) 444, a graphics subsystem 448, and/or an output display interface 449. For explanatory purposes, all components in the computer 400 are shown in FIG. 4 as being coupled via the bus 437. However, the computer 400 is not so limited. Devices of the computer 400 may be coupled via one or more data transport means. For example, the processor device 430 and/or the main memory 435 may be coupled via a local microprocessor bus. The mass storage device 440, peripheral device(s) 442, portable storage medium device(s) 446, and/or graphics subsystem 448 may be coupled via one or more input/output (I/O) buses. The mass storage device 440 may be a non-volatile storage device for storing data and/or instructions for use by the processor device 430. The mass storage device 440 may be implemented, for example, with a magnetic disk drive or an optical disk drive. In a software embodiment, the mass storage device 440 is configured for loading contents of the mass storage device 440 into the main memory 435.

The portable storage medium device 446 operates in conjunction with a nonvolatile portable storage medium, such as, for example, a compact disc read only memory (CD-ROM), to input and output data and code to and from the computer 400. In some embodiments, the software for storing information may be stored on a portable storage medium, and may be inputted into the computer 400 via the portable storage medium device 446. The peripheral device(s) 442 may include any type of computer support device, such as, for example, an input/output (I/O) interface configured to add additional functionality to the computer 400. For example, the peripheral device(s) 442 may include a network interface card for interfacing the computer 400 with a network 439.

The input control device(s) 444 provide a portion of the user interface for a user of the computer 400. The input control device(s) 444 may include a keypad and/or a cursor control device. The keypad may be configured for inputting alphanumeric characters and/or other key information. The cursor control device may include, for example, a mouse, a trackball, a stylus, and/or cursor direction keys. In order to display textual and graphical information, the computer 400 may include the graphics subsystem 448 and the output display 449. The output display 449 may include a cathode ray tube (CRT) display and/or a liquid crystal display (LCD). The graphics subsystem 448 receives textual and graphical information, and processes the information for output to the output display 449.

Each component of the computer 400 may represent a broad category of a computer component of a general and/or special purpose computer. Components of the computer 400 are not limited to the specific implementations provided here.

Software embodiments of the example embodiments presented herein may be provided as a computer program product, or software, that may include an article of manufacture on a machine-accessible or machine-readable medium having instructions. The instructions on the non-transitory machine-accessible machine-readable or computer-readable medium may be used to program a computer system or other electronic device. The machine- or computer-readable medium may include, but is not limited to, floppy diskettes, optical disks, CD-ROMs, and magneto-optical disks or other types of media/machine-readable medium suitable for storing or transmitting electronic instructions. The techniques described herein are not limited to any particular software configuration. They may find applicability in any computing or processing environment. The terms “computer-readable”, “machine-accessible medium” or “machine-readable medium” used herein shall include any medium that is capable of storing, encoding, or transmitting a sequence of instructions for execution by the machine and that causes the machine to perform any one of the methods described herein. Furthermore, it is common in the art to speak of software, in one form or another (e.g., program, procedure, process, application, module, unit, logic, and so on), as taking an action or causing a result. Such expressions are merely a shorthand way of stating that the execution of the software by a processing system causes the processor to perform an action to produce a result.

Portions of the example embodiments of the invention may be conveniently implemented by using a conventional general purpose computer, a specialized digital computer and/or a microprocessor programmed according to the teachings of the present disclosure, as is apparent to those skilled in the computer art. Appropriate software coding may readily be prepared by skilled programmers based on the teachings of the present disclosure.

Some embodiments may also be implemented by the preparation of application-specific integrated circuits, field-programmable gate arrays, or by interconnecting an appropriate network of conventional component circuits.

Some embodiments include a computer program product. The computer program product may be a storage medium or media having instructions stored thereon or therein which can be used to control, or cause, a computer to perform any of the procedures of the example embodiments of the invention. The storage medium may include without limitation a floppy disk, a mini disk, an optical disc, a Blu-ray Disc, a DVD, a CD or CD-ROM, a micro-drive, a magneto-optical disk, a ROM, a RAM, an EPROM, an EEPROM, a DRAM, a VRAM, a flash memory, a flash card, a magnetic card, an optical card, nanosystems, a molecular memory integrated circuit, a RAID, remote data storage/archive/warehousing, and/or any other type of device suitable for storing instructions and/or data.

Stored on any one of the computer-readable medium or media, some implementations include software for controlling both the hardware of the general and/or special computer or microprocessor, and for enabling the computer or microprocessor to interact with a human user or other mechanism utilizing the results of the example embodiments of the invention. Such software may include without limitation device drivers, operating systems, and user applications. Ultimately, such computer-readable media further include software for performing example aspects of the invention, as described above.

Included in the programming and/or software of the general and/or special purpose computer or microprocessor are software modules for implementing the procedures described above.

While various example embodiments of the present invention have been described above, it should be understood that they have been presented by way of example, and not limitation. It will be apparent to persons skilled in the relevant art(s) that various changes in form and detail can be made therein. Thus, the present invention should not be limited by any of the above-described example embodiments, but should be defined only in accordance with the following claims and their equivalents.

In addition, it should be understood that the FIGS. 1-4 are presented for example purposes only. The architecture of the example embodiments presented herein is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

What is claimed is:

1. A method for reducing aggregate portfolio statistics, comprising the steps of:
identifying two or more trades that can be netted, wherein the two or more trades have different fixed rates; and
representing a net of underlying trade cash flows of the two or more trades by replacing the two or more trades with two or fewer replacement trades having an aggregate notional amount that is smaller than an aggregate notional amount of the two or more trades.

2. The method according to claim 1, wherein the step of identifying includes comparing a plurality of attributes of the two or more trades, correspondingly.

3. The method of claim 1, wherein the two or fewer replacement trades is either one of (i) a fixed fixed interest rate swap trade, (ii) an interest rate swap trade, (iii) a combination of a fixed fixed interest rate swap trade and an interest rate swap trade, or (iv) two interest rate swap trades, representing the net of residual fixed side cash flows.

4. The method of claim 3, wherein when the two or fewer replacement trades are two interest rate swap trades, one of the two interest rate swap trades is a pay-fixed interest rate swap at a lowest fixed rate of the two or more trades minus a predetermined percentage and the other one of the two interest rate swap trades is a received-fixed interest rate swap at a highest fixed rate of the two or more trades plus the predetermined percentage.

5. The method according to claim 1, further comprising the steps of:
calculating a net notional amount of the two or more trades;
upon determining that the net notional amount is zero:
calculating a net of residual fixed side cash flows of the two or more trades,
determining whether the net residual fixed side cash flows of the two or more trades are outstanding,
upon determining that the net residual fixed side cash flows are outstanding, booking two replacement trades to represent the residual fixed side cash flows of the two or more trades, and
upon determining that the net residual fixed side cash flows of the two or more trades are not outstanding, terminating the two or more trades; and
upon determining that the net notional amount of the two or more trades is not zero:
calculating a range based on a minimum and maximum of a plurality of fixed rates of the two or more trades,
varying the range by a predetermined percentage,
calculating a notional-weighted average fixed rate to apply to a net notional amount of a replacement trade, and
upon determining that the notional-weighted average fixed rate is outside the range:
replacing the two or more trades with the two replacement trades, correspondingly, and
terminating the two or more trades, and
upon determining that the notional-weighted average fixed rate is within the range:
upon determining that the notional-weighted average fixed rate generates a cash flow equal to the net fixed cash flows of the two or more trades:
replacing the two or more trades with the replacement trade at the notional-weighted average fixed rate, correspondingly, and
terminating the two or more trades, and
upon determining that the notional-weighted average fixed rate generates a cash flow that is not equal to the net fixed cash flows of the two or more trades:
booking two replacement trades in place of the two or more trades at rates with the net notional amount distributed across the two replacement trades to generate fixed cash flows equal to the net fixed cash flows of the two or more trades, correspondingly.

6. The method according to claim 5, wherein the step of identifying includes comparing a plurality of attributes of the two or more trades, correspondingly.

7. The method of claim 5, wherein the two replacement trades is either one of (i) a fixed fixed interest rate swap trade, (ii) an interest rate swap trade, (iii) a combination of a fixed fixed interest rate swap trade and an interest rate swap trade, or (iv) two interest rate swap trades, representing the net of residual fixed side cash flows, and wherein the replacement trade is a fixed fixed interest rate swap trade representing the net of residual fixed side cash flows.

8. The method of claim 5, wherein when the two or fewer replacement trades are two interest rate swap trades, one of the two interest rate swap trades is a pay-fixed interest rate swap at a lowest fixed rate of the two or more trades minus the predetermined percentage and the other one of the two interest rate swap trades is a received-fixed interest rate swap at a highest fixed rate of the two or more trades plus the predetermined percentage.

9. The method according to claim 5, further comprising the step of:
comparing the cash flow generated by the notional-weighted average fixed rate to the net fixed cash flows of the two or more trades based on a predetermined level of rounding.

10. A non-transitory computer-readable medium having stored thereon one or more sequences of instructions for causing one or more processors to perform:
identifying two or more trades that can be netted, wherein the two or more trades have different fixed rates; and
representing a net of underlying trade cash flows of the two or more trades by replacing the two or more trades with two or fewer replacement trades having an aggregate notional amount that is smaller than an aggregate notional amount of the two or more trades.

11. The computer-readable medium of claim 10, wherein the identifying includes comparing a plurality of attributes of the two or more trades, correspondingly.

12. The computer-readable medium of claim 10, wherein the two or fewer replacement trades is either one of (i) a fixed fixed interest rate swap trade, (ii) an interest rate swap trade, (iii) a combination of a fixed fixed interest rate swap trade and an interest rate swap trade, or (iv) two interest rate swap trades, representing the net of residual fixed side cash flows.

13. The method of claim 12, wherein when the two or fewer replacement trades are two interest rate swap trades, one of the two interest rate swap trades is a pay-fixed interest rate swap at a lowest fixed rate of the two or more trades minus a predetermined percentage and the other one of the two interest rate swap trades is a received-fixed interest rate swap at a highest fixed rate of the two or more trades plus the predetermined percentage.

14. The computer-readable medium of claim 10, further having stored thereon a sequence of instructions for causing the one or more processors to perform:
calculating a net notional amount of the two or more trades;
upon determining that the net notional amount is zero:
calculating a net of residual fixed side cash flows of the two or more trades,
determining whether the net residual fixed side cash flows of the two or more trades are outstanding,
upon determining that the net residual fixed side cash flows are outstanding, booking two replacement trades to represent the residual fixed side cash flows of the two or more trades, and
upon determining that the net residual fixed side cash flows of the two or more trades are not outstanding, terminating the two or more trades; and
upon determining that the net notional amount of the two or more trades is not zero:
calculating a range based on a minimum and maximum of a plurality of fixed rates of the two or more trades,
varying the range by a predetermined percentage,
calculating a notional-weighted average fixed rate to apply to a net notional amount of a replacement trade, and
upon determining that the notional-weighted average fixed rate is outside the range:
replacing the two or more trades with the two replacement trades, correspondingly, and
terminating the two or more trades, and
upon determining that the notional-weighted average fixed rate is within the range:
upon determining that the notional-weighted average fixed rate generates a cash flow equal to the net fixed cash flows of the two or more trades:
replacing the two or more trades with the replacement trade at the notional-weighted average fixed rate, correspondingly, and
terminating the two or more trades, and
upon determining that the notional-weighted average fixed rate generates a cash flow that is not equal to the net fixed cash flows of the two or more trades:
booking two replacement trades in place of the two or more trades at rates with the net notional amount distributed across the two replacement trades to generate fixed cash flows equal to the net fixed cash flows of the two or more trades, correspondingly.

15. The computer-readable medium of claim 14, wherein the identifying includes comparing a plurality of attributes of the two or more trades, correspondingly.

16. The computer-readable medium of claim 14, wherein the two replacement trades are either one of (i) a fixed fixed interest rate swap trade, (ii) an interest rate swap trade, (iii) a combination of a fixed fixed interest rate swap trade and an interest rate swap trade, or (iv) two interest rate swap trades, representing the net of residual fixed side cash flows, and wherein the replacement trade is a fixed fixed interest rate swap trade representing the net of residual fixed side cash flows.

17. The method of claim 16, wherein when the two or fewer replacement trades are two interest rate swap trades, one of the two interest rate swap trades is a pay-fixed interest rate swap at a lowest fixed rate of the two or more trades minus a predetermined percentage and the other one of the two interest rate swap trades is a received-fixed interest rate swap at a highest fixed rate of the two or more trades plus the predetermined percentage.

18. The computer-readable medium of claim 16 further having stored thereon a sequence of instructions for causing the one or more processors to perform:
comparing the cash flow generated by the notional-weighted average fixed rate to the net fixed cash flows of the two or more trades based on a predetermined level of rounding.

19. A system for executing a trade, comprising:
a processor in communication with a memory, the memory storing instructions that, when executed by the processor, cause the processor to be operable to control:
identification of two or more trades that can be netted, wherein the two or more trades have different fixed rates; and
representation of a net of underlying trade cash flows of the two or more trades by replacing the two or more trades with two or fewer replacement trades having an aggregate notional amount that is smaller than an aggregate notional amount of the two or more trades.

20. The system according to claim 19, wherein the identification includes a comparison of a plurality of attributes of the two or more trades, correspondingly.

21. The system according to claim 19, wherein the two or fewer replacement trades are either one of (i) a fixed fixed interest rate swap trade, (ii) an interest rate swap trade, (iii) a combination of a fixed fixed interest rate swap trade and an interest rate swap trade, or (iv) two interest rate swap trades, representing the net of residual fixed side cash flows.

22. The method of claim 21, wherein when the two or fewer replacement trades are two interest rate swap trades, one of the two interest rate swap trades is a pay-fixed interest rate swap at a lowest fixed rate of the two or more trades minus a predetermined percentage and the other one of the two interest rate swap trades is a received-fixed interest rate swap at a highest fixed rate of the two or more trades plus the predetermined percentage.

23. The system according to claim 19, wherein the instructions further cause the processor to be operable to control:
calculation of a net notional amount of the two or more trades;
determination of whether the net notional amount is zero;
upon a determination that the net notional amount is zero:
calculation of a net of residual fixed side cash flows of the two or more trades,
determination of whether the net residual fixed side cash flows of the two or more trades are outstanding,
upon a determination that the net residual fixed side cash flows are outstanding, booking of two replacement trades to represent the residual fixed side cash flows of the two or more trades, and
upon a determination that the net residual fixed side cash flows of the two or more trades are not outstanding, termination of the two or more trades; and
upon a determination that the net notional amount of the two or more trades is not zero:
calculation of a range based on a minimum and maximum of a plurality of fixed rates of the two or more trades,
variation of the range by a predetermined percentage,
calculation of a notional-weighted average fixed rate to apply to a net notional amount of a replacement trade, and
upon a determination that the notional-weighted average fixed rate is outside the range:
replacement of the two or more trades with the two replacement trades, correspondingly, and
termination of the two or more trades, and
upon a determination that the notional-weighted average fixed rate is within the range:
upon a determination that the notional-weighted average fixed rate generates a cash flow equal to the net fixed cash flows of the two or more trades:
replacement of the two or more trades with the replacement trade at the notional-weighted average fixed rate, correspondingly, and
termination of the two or more trades, and
upon a determination that the notional-weighted average fixed rate generates a cash flow that is not equal to the net fixed cash flows of the two or more trades:
booking of two replacement trades in place of the two or more trades at rates with the net notional amount distributed across the two replacement trades to generate fixed cash flows equal to the net fixed cash flows of the two or more trades, correspondingly.

24. The system according to claim 23, wherein the identification includes a comparison of a plurality of attributes of the two or more trades, correspondingly.

25. The system according to claim 23, wherein the two replacement trades are either one of (i) a fixed fixed interest rate swap trade, (ii) an interest rate swap trade, (iii) a combination of a fixed fixed interest rate swap trade and an interest rate swap trade, or (iv) two interest rate swap trades, representing the net of residual fixed side cash flows, and wherein the replacement trade is a fixed fixed interest rate swap trade representing the net of residual fixed side cash flows.

26. The method of claim 25, wherein when the two or fewer replacement trades are two interest rate swap trades, one of the two interest rate swap trades is a pay-fixed interest rate swap at a lowest fixed rate of the two or more trades minus the predetermined percentage and the other one of the two interest rate swap trades is a received-fixed interest rate swap at a highest fixed rate of the two or more trades plus the predetermined percentage.

27. The system according to claim 23, wherein the instructions further cause the processor to be operable to control a comparison of the cash flow generated by the notional-weighted average fixed rate to the net fixed cash flows of the two or more trades based on a predetermined level of rounding.
